(19) United States
(12) Patent Application Publication
(10) Pub. No.: US 2026/0042286 A1
(43) Pub. Date: Feb. 12, 2026

(54) PAD PRINTING CARRIER AND TRANSMISSION DEVICE

(71) Applicant: Suzhou Cai Machine Group Co., Ltd., Suzhou (CN)

(72) Inventors: Fuzhen Wang, Suzhou (CN); Zhiguo Xiao, Suzhou (CN)

(21) Appl. No.: 19/360,988

(22) Filed: Oct. 17, 2025

(30) Foreign Application Priority Data
Nov. 1, 2024 (CN) 202411549728.X

(51) Int. Cl. B41F 17/00; B41F 21/00

(52) U.S. Cl. CPC B41F 17/002; B41F 17/001; B41F 17/006; B41F 21/00

(57) ABSTRACT

A pad printing carrier including a bucket mold and at least one breathing valve assembly. The bucket mold is used for holding a bucket-shaped workpiece and defines a cavity, an air inlet hole, at least one air outlet hole, and an airflow channel, the air inlet hole, the at least one air outlet hole, and the airflow channel are communicated with the cavity. The at least one breathing valve assembly is coupled with the at least one air outlet hole and each includes a counterweight unit, the weight of the counterweight unit is greater than the thrust generated by the air flow passing through the air outlet hole during demolding. A transmission device including the pad printing carrier is also provided.

### CROSS-REFERENCE TO RELATED APPLICATIONS

This application claims priority to Chinese patent application No. 202411549728.X filed on November 1, 2024, entitled “Pad printing carrier and transmission device”, the entire contents of which are incorporated herein by reference.

### TECHNICAL FIELD

The present disclosure relates to the field of pad printing technology, specifically to a pad printing carrier and a transmission device.

### BACKGROUND

With the development of pad printing technology, it has been widely applied to curved workpieces, especially to bucket-shaped workpieces. Since the printed pattern covers the outer peripheral surface of the bucket-shaped workpiece, in order to ensure the positioning effect, existing carriers often use the method of inserting the bucket-shaped workpiece from its opening onto the carrier. However, during the process of using the carrier to hold the bucket-shaped workpiece, the inventor found the following problems:

In order to ensure the stability of bucket-shaped workpiece, the carrier is in close contact with the bucket-shaped workpiece and a sealing cavity is easily created between the carrier and the bucket-shaped workpiece. When the bucket-shaped workpiece is loaded on the carrier, the space between the bucket-shaped workpiece and the carrier is reduced, and the gas is compressed. The positive pressure gas will cause the bucket-shaped workpiece to be obstructed when entering the fixture; or it will cause the bucket-shaped workpiece to be not properly positioned in the carrier, making it difficult to ensure the printing position and quality.

During use, it is necessary to release the positive pressure gas generated during the loading of the carrier. In addition, in order to avoid the bucket-shaped workpiece from shifting after loaded on the carrier, a method of drawing a negative pressure between the carrier and the bucket-shaped workpiece is often used. If the negative pressure drawing method is used to release the positive pressure gas during loading, the negative pressure drawing process will require going through the process of: drawing the positive pressure state of the sealed cavity to the atmospheric pressure state, and then drawing it to the negative pressure state, resulting in a long time required for negative pressure drawing, reducing the material supply speed, and affecting the overall production efficiency of the equipment.

### SUMMARY

To solve the above technical problems, embodiments of the present disclosure provide the following technical solutions:

On one hand, the present disclosure provides a pad printing carrier including a bucket mold and at least one breathing valve assembly. The bucket mold is used for holding a bucket-shaped workpiece and defines a cavity, an air inlet hole, at least one air outlet hole, and an airflow channel, the air inlet hole, the at least one air outlet hole, and the airflow channel are communicated with the cavity, The at least one breathing valve assembly is coupled with the at least one air outlet hole and each includes a counterweight unit, the weight of the counterweight unit is greater than the thrust generated by the air flow passing through the air outlet hole during demolding.

In one embodiment, the air outlet hole is located within a projection range of the counterweight unit on the bucket mold along a direction of movement of the counterweight unit.

In one embodiment, each of the at least one breathing valve assembly further includes a limiting unit and an elastic unit, the limiting unit is connected to the bucket mold, the counterweight unit is sleeved on the limiting unit, the elastic unit abuts against the counterweight unit and presses the counterweight unit to cover the air outlet hole.

In one embodiment, each of the at least one breathing valve assembly further includes a breathing sheet, a limiting unit, and an elastic unit, the limiting unit is connected to the bucket mold, the breathing sheet and the elastic unit are sleeved on the limiting unit, the breathing sheet covers the air outlet hole, the elastic unit is arranged between the breathing sheet and the counterweight unit.

In one embodiment, the air inlet hole and the air outlet hole are respectively arranged on opposite sides of the bucket mold, a bottom of the bucket-shaped workpiece is in contact with the side where the air inlet hole is located; the air outlet hole and the airflow channel are located on the same side of the bucket mold.

In one embodiment, the bucket mold further includes an air pipe protruding from a center of a side where air outlet hole is located, the airflow channel is defined inside the air pipe.

In one embodiment, the number of the at least one air outlet holes is at least two, the air outlet holes are arranged around the air pipe, and the position of the breathing valve assembly corresponds to the air outlet holes.

In one embodiment, the limiting unit includes a pin, the bucket mold defines an installation hole, the pin is installed in the installation hole.

On another hand, the present disclosure provides a transmission device, including: a rotating shaft having an axis and horizontally arranged; a rotating disc, connected to the rotating shaft and including multiple connecting units, and a plurality of aforementioned pad printing carriers, the plurality of pad printing carriers are connected to the connecting unit respectively; wherein the transmission device includes at least an in-bucket position and an out-bucket position, the in-bucket position is level with or above a horizontal plane on which the axis of the rotating shaft is located, and the out-bucket position is located below the horizontal plane of the axis of the rotating shaft.

In one embodiment, the transmission device further includes an air pump, used for inflation to form a positive pressure during demolding or suction to form a negative pressure, the air pump is connected to the cavity through the connecting units, when the pad printing carrier is at the in-bucket position, the air pump sucks air to form a negative pressure in the cavity, when the pad printing carrier is at the out-bucket position, the air pump inflates to form positive pressure in the cavity for demolding.

The present disclosure has at least the following benefits:

In the present disclosure, by setting up a breathing valve assembly, the air leading to positive pressure in the cavity during loading the bucket-shaped workpiece is released through the air outlet hole, so as to quickly exhaust the gas in the cavity, avoid the bucket-shaped workpiece from being obstructed when loaded onto the carrier. This speeds up the supply speed and improves the pad printing efficiency.

By matching the counterweight unit and the layout of the out-bucket position, the self-weight of the counterweight unit is used for controlling the open or close of the air outlet hole, ensuring that during the demolding process, air for generating positive pressure is introduced between the bucket-shaped workpiece and the bucket mold, and the air outlet hole will not leak gas. The positive pressure gas pushes the bucket-shaped workpiece to unload so as to improve the demolding efficiency. The breathing valve assembly uses a mechanical structure to flexibly control the opening and closing of the air outlet hole, with a simple structure, reliable use, and low manufacturing cost.

### BRIEF DESCRIPTION OF DRAWINGS

To more clearly illustrate the technical solutions in the present disclosure or prior art, a brief description of the accompanying drawing to be used in the description of the embodiments or prior art will be given below. The drawing described below is obviously just embodiment/embodiments of the present disclosure. For ordinary technicians in this field, other drawings can be obtained based on the drawing without doing creative work.

FIG. 1 is a sectional view of the pad printing carrier provided in one embodiment of the present disclosure, which includes a bucket mold and a breathing valve assembly.

FIG. 2 is an enlarged view of area “A” in FIG. 1.

FIG. 3 is another sectional view of the bucket mold provided in FIG. 1, with the breathing valve assembly being removed.

FIG. 4 is a schematic view of the pad printing carrier in the FIG. 1 in another perspective.

FIG. 5 is a partial structure diagram of a transmission device provided in one embodiment of the present disclosure.

Reference numerals:

100, transmission device; 101, rotating disc; 102, air pump; 10, pad printing carrier; 11, bucket mold; 12, counterweight unit; 13, breathing sheet; 14, limiting unit; 15, elastic unit; 111, outer shell; 112, partition; 113, cover plate; 114, air pipe; 1111, cavity; 1112, recess; 1121, air outlet hole; 1122, clearance groove; 1123, installation hole; 1131, air inlet hole; 1141, airflow channel; 141, pin; 142, fixing block; 19, breathing valve assembly; 21, rotating shaft; 22, connecting unit; 30, in-bucket position; 40, corona position; 50, positioning position; 60, pad printing position; 70, curing position; 80, out-bucket position.

### DESCRIPTION OF EMBODIMENTS

To make the above-mentioned objects, features and advantages of the present disclosure more obvious and easier to understand, the specific implementations of the present disclosure are described in detail below with reference to the accompanying drawings. In the following description, numerous specific details are set forth to provide a thorough understanding of the present disclosure. However, the present disclosure can be implemented in many other ways different from those described herein, and those skilled in the art can make similar improvements without violating the connotation of the present disclosure. Therefore, the present disclosure is not limited to the specific embodiments disclosed below.

In the description of the present disclosure, it should be understood that if the terms "length", "width", "thickness", "up", "down", "vertical", "inside", "outside", "clockwise", "counterclockwise", "axial", "radial", "circumferential", etc. appear, the orientation or position relationship indicated by these terms is based on the orientation or position relationship shown in the drawings, which is only for the convenience of describing the present disclosure and simplifying the description, and does not indicate or imply that the device or element referred to must have a specific orientation, be constructed and operated in a specific orientation, and therefore cannot be understood as a limitation on the present disclosure.

In addition, if the terms "first", "second", and "third", etc. appear, these terms are used for descriptive purposes only and cannot be understood as indicating or implying relative importance or implicitly indicating the quantity of the indicated technical features. Therefore, features defined as “first”, “second”, and “third” may explicitly or implicitly include at least one of these features. In the description of the present disclosure, if the term "plurality", "a number of ", "numerous", etc. appears, they mean at least two, for example, two, three, etc., unless otherwise clearly and specifically defined.

In present disclosure, unless otherwise clearly specified or limited, if the terms "installed", "connected", "connected", "fixed" and the like appear, these terms should be understood in a broad sense. For example, it can be a fixed connection, a detachable connection, or an integrated connection; it can be a mechanical connection or an electrical connection; it can be directly connected or indirectly connected through an intermediate medium; it can be internal communication between two elements or an interaction relationship between two elements, unless otherwise clearly defined. For those skilled in the art, the specific meanings of the above terms in present disclosure can be understood according to specific circumstances.

In the present disclosure, unless otherwise clearly specified and limited, if there is a description that a first feature is "on" or "below" or "above" a second feature, etc., or similar description, it may mean that the first and second features are in direct contact, or the first and second features are in indirect contact through an intermediate medium. Moreover, “on”, “above” and “on top of” a first feature may mean that the first feature is directly above or obliquely above the second feature, or simply means that the first feature is at a higher level than the second feature. A first feature being “beneath” or “below” a second feature may mean that the first feature is directly below or diagonally below the second feature, or simply means that the first feature is at a smaller horizontal height than the second feature.

It should be noted that, if an element is referred to as being “fixed on” or “disposed on” or “provided on” another element, it may be directly on the other element or there may be a central element. If an element is considered to be "connected to" another element, it can be directly connected to the other element or there may be intervening elements at the same time. If present, the terms "vertical", "horizontal", "up", "down", "left", "right" and similar expressions used in present disclosure are for illustrative purposes only and do not represent the only implementation method.

The embodiments of the present disclosure are described in detail below with reference to the accompanying drawings.

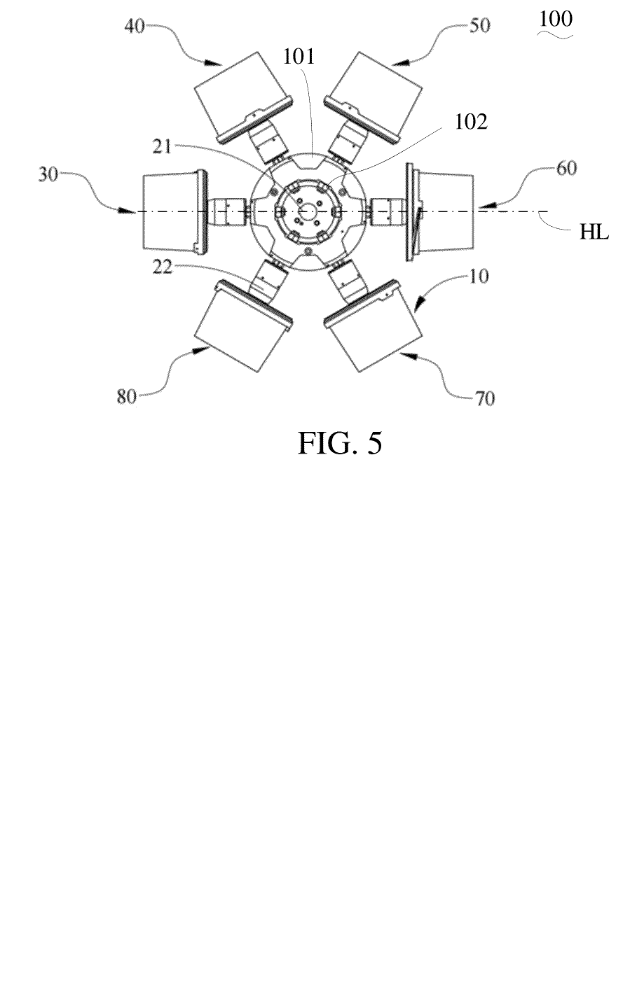

Referring to FIG. 5, in some embodiments of the present disclosure, the present disclosure provides a transmission device 100, which includes: a rotating shaft 21, a rotating disc 101, a pad printing carrier 10, and an air pump 102. The rotating disc 101 is connected to the rotating shaft 21, and the rotating shaft 21 can drive the rotating disc 101 to rotate around the axis of the rotating shaft 21. The rotating disc 101 has multiple connecting units 22, and the pad printing carrier 10 is connected to the connecting unit 22.

Specifically, the transmission device 100 has an in-bucket position 30, a corona position 40, a positioning position 50, a pad printing position 60, a curing position 70, and an out-bucket position 80. The in-bucket position 30, corona position 40, positioning position 50, pad printing position 60, curing position 70, and out-bucket position 80 are sequentially distributed on the outer periphery of the rotating disc 101. At the in-bucket position 30, corona position 40, positioning position 50, pad printing position 60, curing position 70, and out-bucket position 80, the various processes of pad printing can be carried out at each work position. The rotating shaft 21 can drive the rotating disc 101 to rotate, so that the pad printing carrier 10 connected to the connecting unit 22 can be positioned correspond to the in-bucket position 30, corona position 40, positioning position 50, pad printing position 60, curing position 70, and out-bucket position 80 respectively.

In this embodiment, functional devices are set close to the in-bucket position 30, corona position 40, positioning position 50, pad printing position 60, curing position 70, and out-bucket position 80 to perform different functional processes on the pad printing carrier 10 closest to them. The functional devices cyclically perform the processes of in-bucket, corona, positioning, pad printing, curing, and out-bucket on the bucket-shaped workpiece, thereby automatically realizing the pad printing.

In this embodiment, the transmission device 100 drives the bucket-shaped workpiece to move and transfers the bucket-shaped workpiece to the pad printing equipment to perform pad printing on the curved surface of the bucket-shaped workpiece. Due to the structural limitations of the bucket-shaped workpiece, in order to evenly print the pattern to the surface of the bucket-shaped workpiece, the connecting unit 22 can also drive the pad printing carrier 10 to rotate around the axis of the connecting unit 22 so as to better carry out the pad printing to the outer peripheral surface of the bucket-shaped workpiece.

In the actual process, when the bucket-shaped workpiece is loaded onto the pad printing carrier 10, if the gas between the bucket-shaped workpiece and the pad printing carrier 10 is not exhausted smoothly, the gas will be squeezed, resulting in positive pressure. The positive pressure gas will affect the loading of the bucket-shaped workpiece into the pad printing carrier 10 in place. To solve the above-mentioned problems, the existing technology uses the method of drawing air to reduce the air pressure between the bucket-shaped workpiece and the pad printing carrier 10. In this process, the positive pressure state of the sealed cavity is first drawn to the atmospheric pressure state, and then to the negative pressure state. However, in the process of drawing the positive pressure state to the atmospheric state, it is also necessary to push the bucket-shaped workpiece to continue moving towards the pad printing carrier 10 to ensure that the bucket-shaped workpiece is installed in a fixed position. In the process of drawing the positive pressure state to the atmospheric state, in fact, when the bucket-shaped workpiece continues to move on, the air pressure between the bucket-shaped workpiece and the pad printing carrier 10 will rise again, and then the positive pressure state between the bucket-shaped workpiece and the pad printing carrier 10 is drawn to the atmospheric state, and so on. Finally, the bucket-shaped workpiece is loaded onto a fixed position, and the air pressure between the bucket-shaped workpiece and the pad printing carrier 10 is in the atmospheric state.

Since the negative pressure state, which is slightly lower than the atmospheric pressure, can fix the position of the bucket-shaped workpiece and the pad printing carrier 10, in order to reduce costs and reduce the damage to the bucket-shaped workpiece caused by low pressure, the power of the air pump 102 is small. However, a small power air pump 102 will greatly affect the time consumed in the cycle of drawing the positive pressure state to the atmospheric state, resulting in low feeding efficiency of the transmission device 100, and thereby affecting the transmission efficiency and pad printing efficiency.

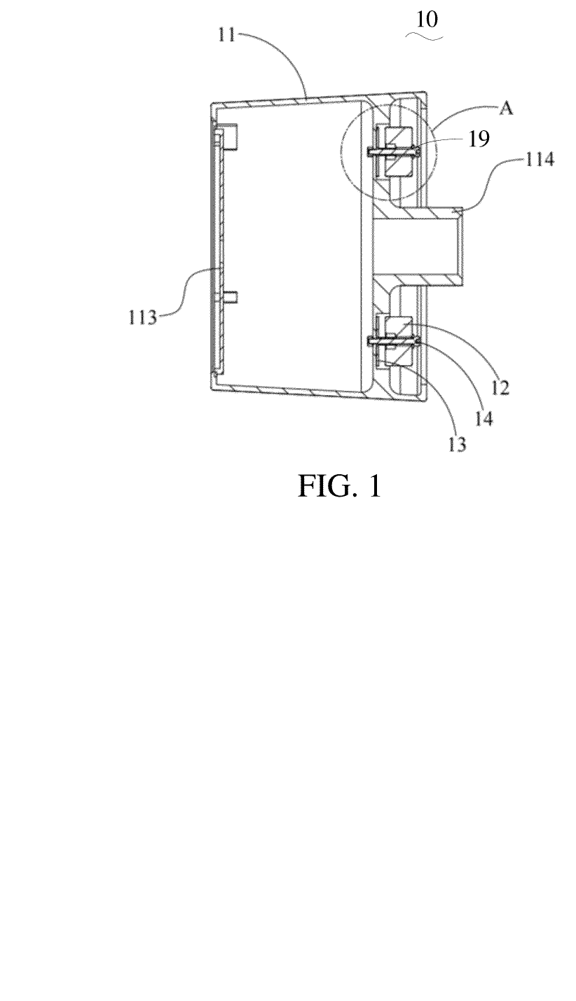

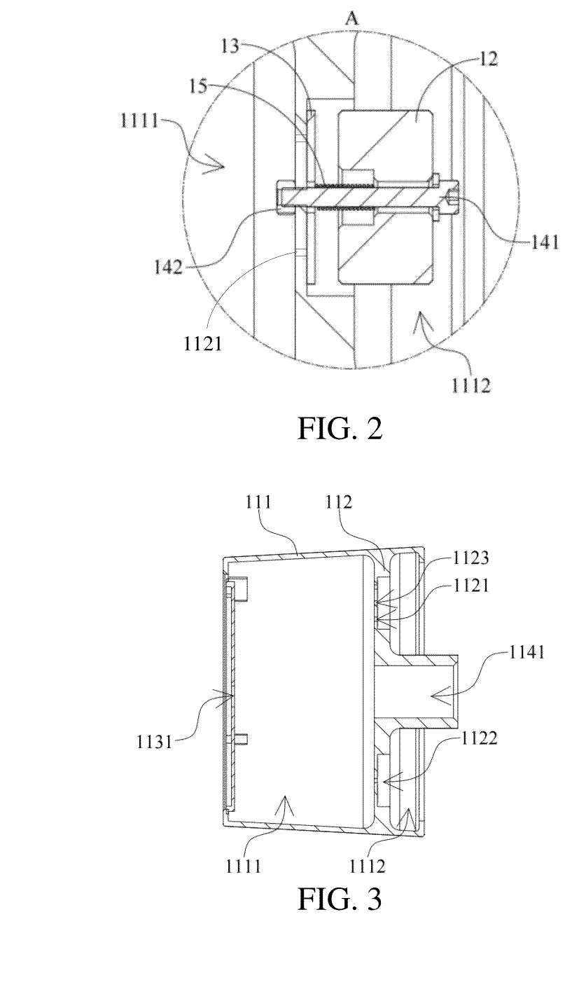

In some embodiments of the present disclosure, as shown in FIGS. 1 to 3, the pad printing carrier 10 includes a bucket mold 11 and a breathing valve assembly 19. The bucket mold 11 has a hollow cavity 1111 inside, and an air inlet hole 1131 is provided on one surface of the bucket mold 11, which is communicated to the cavity 1111. When the bucket-shaped workpiece is loaded onto the bucket mold 11, the air inlet hole 1131 is covered by the bucket-shaped workpiece. The bucket mold 11 has an air outlet hole 1121 and an airflow channel 1141 on another surface of the bucket mold 11, and the air outlet hole 1121 and the airflow channel 1141 are both communicated with the cavity 1111. When the bucket-shaped workpiece is loaded onto the bucket mold 11, the bottom of the bucket-shaped workpiece is in contact with the surface where the air inlet hole 1131 is located, so that the bucket-shaped workpiece covers the air inlet hole 1131; at the same time, the air outlet hole 1121 is not covered by the bucket-shaped workpiece to ensure that the air outlet hole 1121 can exhaust air normally.

The breathing valve assembly 19 is coupled with the air outlet hole 1121 and is used to control the opening and closing of the air outlet hole 1121. When the breathing valve assembly 19 closes the air outlet hole 1121, the cavity 1111 and the airflow channel 1141 form a sealed space. At this time, when the air pump 102 operates to suck air, a negative pressure is generated in the cavity 1111, so that the cavity 1111 and the airflow channel 1141 maintain a negative pressure state, causing the bucket-shaped workpiece to be adsorbed on the bucket mold 11. Alternatively, the air pump 102 operates to inflate the cavity 1111 to generate a positive pressure, and the air pressure in the cavity 1111 and the airflow channel 1141 gradually increases, causing the bucket-shaped workpiece to gradually separate from the bucket mold 11.

In this embodiment, the breathing valve assembly 19 includes a counterweight unit 12, a breathing sheet 13, a limiting unit 14, and an elastic unit 15. The limiting unit 14 is connected to the bucket mold 11 and is located close to the air outlet hole 1121. The breathing sheet 13 is provided on the outer side of the cavity 1111 and covers the air outlet hole 1121. The counterweight unit 12 is connected to the limiting unit 14 and can move towards the air outlet hole 1121 along the limiting unit 14. The elastic unit 15 is arranged between the breathing sheet 13 and the counterweight unit 12. The limiting unit 14 is located close to the air outlet hole 1121 specifically can mean that in some embodiments, when the counterweight unit 12 is in contact with the bucket mold 11, the counterweight unit 12 covers the air outlet hole 1121.

Since the counterweight unit 12 is relatively heavy, the breathing sheet 13 is pressed on the air outlet hole 1121 by the elastic unit 15. On the one hand, during the process of loading the bucket-shaped workpiece, the cavity 1111 contains compressed positive pressure gas. The positive pressure gas pushes the breathing sheet 1121 to move away from the air outlet hole 1121, and the elastic unit 15 deforms elastically, so that the air outlet hole 1121 opens and the gas can be exhausted from the air outlet hole 1121, allowing the cavity 1111 to return to the atmospheric pressure state. Because the cavity 1111 is in the atmospheric pressure state, the bucket-shaped workpiece can be further loaded into the bucket mold 11 without obstruction, ensuring a tight fit between the bucket-shaped workpiece and the bucket mold 11. On another hand, after the cavity 1111 returns to the atmospheric pressure state, the deformed elastic unit 15 returns to its original state, and the breathing sheet 13 covers the air outlet hole 1121 again. In this embodiment, the cooperation of the counterweight unit 12, breathing sheet 13, and elastic unit 15 ensures that the air outlet hole 1121 can open automatically after being opened by the positive pressure gas. When the negative pressure is generated, the cavity 1111 is in a negative pressure state, and the breathing sheet 13 is adsorbed on the air outlet hole 1121, so that the air outlet hole 1121 is closed. According to the position change between the breathing sheet 13 and the air outlet hole 1121, the breathing valve assembly 19 can flexibly control the opening and closing of the air outlet hole 1121.

Further, in the transmission device 100 based on the above-mentioned pad printing carrier 10, the rotating shaft 21 is horizontally set, and the rotating shaft 21 is located on the horizontal plane HL. The axis of the rotating shaft 21 is thus located on the horizontal plane HL, and the rotating disc 101 is perpendicular to the horizontal plane HL. The in-bucket position 30 is level with or above the horizontal plane HL where the axis of the rotating shaft 21 is located. Under such arrangement, the breathing sheet 13 can be easily pushed so that the air inlet hole 1131 open to exhaust air. The out-bucket position 80 is located below the horizontal plane HL where the axis of the rotating shaft 21 is located. The pad printing carrier 10 installed on the connecting unit 22 is rotated one position by one position to the out-bucket position 80.

In this embodiment, the air pump 102 is connected to the connecting unit 22 and finally communicated with the airflow channel 1141. When the air pump 102 switches between the inflation and suction modes, a positive pressure and negative pressure state in the cavity 1111 is generated respectively. When the pad printing carrier 10 installed on the connecting unit 22 is rotated to the out-bucket position 80, the air pump 102 switches from suction mode to inflation mode, increasing the air pressure in the cavity 1111 and causing the bucket-shaped workpiece to quickly separate from the bucket mold 11.

In an embodiment of the present disclosure, the weight of the counterweight unit 12 is greater than the thrust generated by the air flow passing through the air outlet hole 1121 during demolding. Since the out-bucket position 80 is located below the horizontal plane HL where the axis of the rotating shaft 21 is located, like at the six-clock position, at the out-bucket position 80, under the gravity of the counterweight unit 12 of the pad printing carrier 10, the counterweight unit 12 tends to move towards the air outlet hole 1121. The counterweight unit 12 presses the breathing sheet 13 with its own gravity. As the weight of the counterweight unit 12 is greater than the thrust generated by the air flow passing through the air outlet hole 1121 during demolding, it can ensure that the air outlet hole 1121 maintain the close state, and the positive pressure gas can only be exhausted from the air inlet hole 1131 to push the bucket-shaped workpiece. The layout of the counterweight unit 12 and the out-bucket position 80 ensures that when the positive pressure gas pushes the bucket-shaped workpiece to separate from the bucket mold 11, the positive pressure gas is relatively difficult to overflow from the air outlet hole 1121.

It should be noted that, when the out-bucket position 80 is located below the horizontal plane HL, but not at the six-clock position, for the purpose of ensuring the close state of the air outlet hole 1121 during demolding, the pressure on breathing sheet 13 generated by the weight of counterweight unit 12 should be greater than the thrust on the breathing sheet 13 generated by the air in the cavity 1111 during demolding. Therefore, the weight of counterweight unit 12 could be adjusted according to the actual position of the out-bucket position 80.

Although the breathing valve assembly 19 can also use an electromagnetic valve, the rotating disc 101 and the pad printing carrier 10 both rotate, making the movement of the pad printing carrier 10 more complex. The electromagnetic valve requires electrical energy to operate. Since the movement of the pad printing carrier 10 is complex, it is difficult to supply power to the electromagnetic valve of the pad printing carrier 10. The most critical issue is the layout of the power supply line, rotation will cause the power supply line to tangle and knot. In addition, the electromagnetic valve also requires logical algorithm control for opening and closing, and the logical algorithm is more prone to errors, affecting the use of the transmission device 100.

In this embodiment, the design of the breathing valve assembly 19 can flexibly control the opening and closing of the air outlet hole 1121. At least at the in-bucket position 30, the positive pressure gas can overflow from the air outlet hole 1121. Correspondingly, at the out-bucket position 80, the positive pressure gas is difficult to overflow from the air outlet hole 1121. More importantly, the breathing valve assembly 19 uses a mechanical structure to control the opening and closing of the air outlet hole 1121, which is more reliable in use than the electromagnetic valve, has a longer service life, and is lower in manufacturing cost.

At the same time, in order to prevent the pad printing carrier 10 at the in-bucket position 30 from being affected by the self-weight of the counterweight unit 12 pressing on the breathing sheet 13, resulting in the closure of the air outlet hole 1121 and making it difficult for the positive pressure gas to be exhausted from the air outlet hole 1121, which affects the loading position of the bucket-shaped workpiece on the bucket mold 11, in this embodiment, the in-bucket position 30 is level with or above the horizontal plane HL to remove the pressure of the counterweight unit 12 on the breathing sheet 13 and ensure the exhaust capacity of the air outlet hole 1121.

In some embodiments of the present disclosure, the bucket mold 11 includes an outer shell 111, and the outer shell 111 has a hollow cavity inside. The cavity extends to the opposite sides of the outer shell 111 to form openings. One of the openings is covered with a cover plate 113. For example, the outer shell 111 is in the shape of a tube. A partition 112 is provided in the cavity, and the partition 112 divides the cavity into two separate cavities. One of the cavities is covered by the cover plate 113 near the opening, forming the aforementioned cavity 1111. In addition, the other one of the two separate cavities divided by the partition 112 is a recess 1112 on the other side, and the breathing valve assembly 19 is located in the recess 1112. The air inlet hole 1131 is provided on the cover plate 113, and the air outlet hole 1121 and the airflow channel 1141 are provided on the partition 112.

In this embodiment, the breathing valve assembly 19 is located in the recess 1112. Specifically, the breathing valve assembly 19 is fully received in the recess 1112. When the pad printing carrier 10 is moved, it prevents the breathing valve assembly 19 from being interfered by external structures. That is, the counterweight unit 12 is protected by the outer shell 111, reducing the risk of external structures contacting the counterweight unit 12 and causing the counterweight unit 12 to shift and affect the normal opening and closing of the breathing sheet 13.

Further, the partition 112 is provided with an air pipe 114, and the airflow channel 1141 is provided inside the air pipe 114, which extends throughout the air pipe 114. A gas pipe connected to the air pump 102 is provided in the connecting unit 22. After the connecting unit 22 is connected to the air pipe 114, a gas passage is formed between the air pump 102 and the cavity 1111, which allows forming a negative pressure or positive pressure state in the cavity 1111 according to actual needs. At the same time, the connection between the connecting unit 22 and the air pipe 114 realizes the fixed position relationship between the pad printing carrier 10 and the connecting unit 22. The airflow channel 1141 and the gas pipe are respectively provided in the air pipe 114 and the connecting unit 22, reducing the additional gas passages required to form a negative pressure or positive pressure state in the cavity 1111 and simplifying the structural design. In this embodiment, the air pipe 114 is located at the center of the partition 112. The connecting unit 22 is connected to the air pipe 114 to drive the rotation of the pad printing carrier 10, so that the axis of the airflow channel 1141 is on the same line as the rotation axis. The air pipe 114 serves both as a rotation axis and as a gas passage between the air pump 102 and the cavity 1111.

A clearance groove 1122 is provided on the surface of the partition 112 facing away the cover plate 113, and the clearance groove 1122 corresponds to the counterweight unit 12. The counterweight unit 12 can be embedded in the clearance groove 1122, specifically, the projection of the counterweight unit 12 on the bucket mold 11 in the direction of its movement falls within the clearance groove 1122. When the counterweight unit 12 moves towards the air outlet hole 1121 due to gravity, the counterweight unit 12 finally falls into the clearance groove 1122. At the same time, the breathing sheet 13 is located in the clearance groove 1122, and the clearance groove 1122 can also limit the position of the breathing sheet 13. When the counterweight unit 12 presses the breathing sheet 13 through the elastic unit 15, it can also ensure the relative position between the counterweight unit 12 and the breathing sheet 13 to avoid excessive deviation between the counterweight unit 12 and the breathing sheet 13, which affects the airtightness of the air outlet hole 1121.

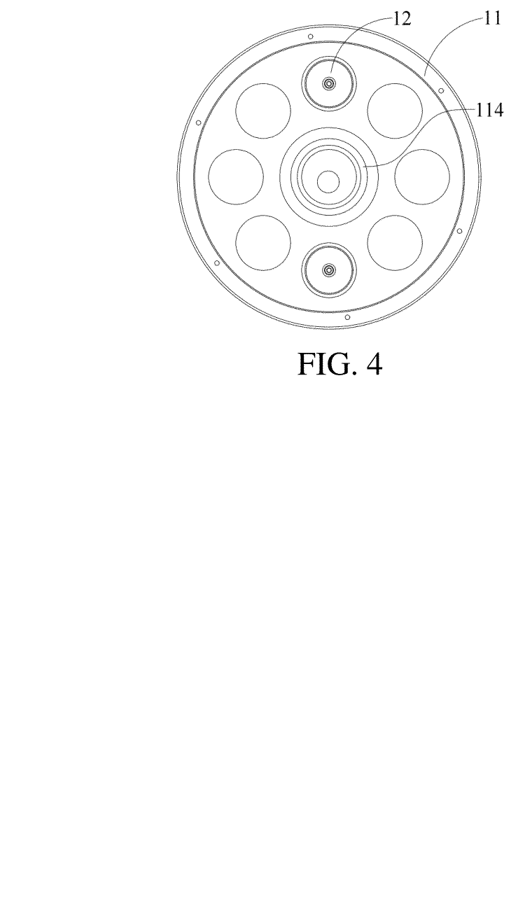

Furthermore, as shown in FIG. 4, the number of air outlet holes 1121 is at least two, and the air outlet holes 1121 are distributed around the airflow channel 1141. Since it is necessary for the connecting unit 22 to drive the pad printing carrier 10 to rotate, and there is a gas passage in the air pipe 114 connected to the connecting unit 22, the air pipe 114 is located at the center of one side surface of the bucket mold 11. Specifically, the outer contour of the bucket mold 11 is adapted to the bucket-shaped workpiece, and the outer contour of the bucket mold 11 is in the shape of a cylinder or a frustum. The air pipe 114 is located at the center of one side surface of the bucket mold 11, including: when the outer contour of the bucket mold 11 is in the shape of a frustum, the air pipe 114 and the air outlet hole 1121 are located on the larger base surface, and the axis of the air pipe 114 is on the same line as the axis of the bucket mold 11. The air pipe 114 and the air outlet hole 1121 are located on the larger base surface, and the opening of the bucket-shaped workpiece is larger than the other smaller base surface of the bucket mold 11, so that the bucket-shaped workpiece can be sleeved on the bucket mold 11.

The number of air outlet holes 1121 is set to multiple, which increases the contact area between the cavity 1111 and the external atmosphere, thereby increasing the exhaust rate of the positive pressure gas in the cavity 1111, and thus improving the loading speed of the pad printing carrier 10 at the in-bucket position 30 and improving production efficiency. In addition, setting multiple air outlet holes 1121 can ensure that the pad printing carrier 10 at the in-bucket position 30 can still load normally even if some of the air outlet holes 1121 fail. Among them, the number of failed air outlet holes is less than the total number of air outlet holes 1121.

In a specific embodiment of the present disclosure, the limiting unit 14 includes a pin 141 and a fixing block 142. The counterweight unit 12 is movably connected to the pin 141, that is, the counterweight unit 12 can move relative to the pin 141. An installation hole 1123 is provided in the bucket mold 11, specifically, the installation hole 1123 is provided in the partition 112. The limiting unit 14 is fixed to the bucket mold 11 through the installation hole 1123.

More specifically, installation hole 1123 passes through partition 112 so as to communicate with the cavity 111. The pin 141 passes through the installation hole 1123 and extends into the cavity 111. The fixing block 142 is threadedly connected to the pin 141, and the fixing block 142 is located inside the cavity 111. In this embodiment, the pin 141 is in interference fit with the installation hole 1123 to ensure the airtightness of the installation hole 1123.

The air outlet hole 1121 is located close to the installation hole 1123. The breathing sheet 13 and the counterweight unit 12 are sleeved on the pin 141, and the breathing sheet 13 and the counterweight unit 12 can move relative to the pin 141. The counterweight unit 12 can move towards the air outlet hole 1121.

In this embodiment, the pin 141 is in a fixed position relative to the bucket mold 11. The counterweight unit 12 is sleeved on the pin 141 and can move relative to the pin 141. The pin 141 can also guide the path of the counterweight unit 12. The breathing sheet 13 can be sleeved on the pin 141, or a clearance space can be provided on the breathing sheet 13 at the position of the pin 141. The breathing sheet 13 can move relative to the outer surface of the bucket mold 11.

Further, the installation hole 1123 is surrounded by at least two air holes 1121, which are covered by the same breathing sheet 13 close to the installation hole 1123. This increases the area of the air holes 1121 covered by a single breathing valve assembly 19, facilitating the rapid exhaustion of positive pressure gas.

The above embodiments are used to further illustrate the present disclosure, but the present disclosure is not limited to these specific embodiments. Any modifications, equivalent substitutions and improvements made within the spirit and principles of present disclosure should be understood to be within the scope of protection of present disclosure.

1. A pad printing carrier, comprising:
a bucket mold (11), used for holding a bucket-shaped workpiece and defining a cavity (1111), an air inlet hole (1131), at least one air outlet hole (1121), and an airflow channel (1141); the air inlet hole (1131), the at least one air outlet hole (1121), and the airflow channel (1141) are communicated with the cavity (1111); and
at least one breathing valve assembly (19), coupled with the at least one air outlet hole (1121) and each comprising a counterweight unit (12), the weight of the counterweight unit (12) is greater than the thrust generated by the air flow passing through the air outlet hole (1121) during demolding.

2. The pad printing carrier according to claim 1, wherein the air outlet hole (1121) is located within a projection range of the counterweight unit (12) on the bucket mold (11) along a direction of movement of the counterweight unit (12).

3. The pad printing carrier according to claim 2, wherein each of the at least one breathing valve assembly (19) further comprises a limiting unit (14) and an elastic unit (15), the limiting unit (14) is connected to the bucket mold (11);
the counterweight unit (12) is sleeved on the limiting unit (14), the elastic unit (15) abuts against the counterweight unit (12) and presses the counterweight unit (12) to cover the air outlet hole (1121).

4. The pad printing carrier according to claim 2, wherein each of the at least one breathing valve assembly (19) further comprises a breathing sheet (13), a limiting unit (14), and an elastic unit (15); the limiting unit (14) is connected to the bucket mold (11), the breathing sheet (13) and the elastic unit (15) are sleeved on the limiting unit (14);
the breathing sheet (13) covers the air outlet hole (1121), the elastic unit (15) is arranged between the breathing sheet (13) and the counterweight unit (12).

5. The pad printing carrier according to claim 1, wherein the air inlet hole (1131) and the air outlet hole (1121) are respectively arranged on opposite sides of the bucket mold (11), a bottom of the bucket-shaped workpiece is in contact with the side where the air inlet hole (1131) is located;
the air outlet hole (1121) and the airflow channel (1141) are located on the same side of the bucket mold (11).

6. The pad printing carrier according to claim 5, wherein the bucket mold (11) further comprises an air pipe (114) protruding from a center of a side where air outlet hole (1121) is located, the airflow channel (1141) is defined inside the air pipe (114).

7. The pad printing carrier according to claim 6, wherein the number of the at least one air outlet holes (1121) is at least two, the air outlet holes (1121) are arranged around the air pipe (114), and the position of the breathing valve assembly (19) corresponds to the air outlet holes (1121).

8. The pad printing carrier according to claim 4, wherein the limiting unit (14) comprises a pin (141), the bucket mold (11) defines an installation hole (1123), the pin (141) is installed in the installation hole (1123).

9. A pad printing carrier, comprising:
a bucket mold (11), used for holding a bucket-shaped workpiece and defining:
an air inlet hole (1131), facing the workpiece when the workpiece is loaded;
a cavity (1111), communicated with air inlet hole (1131);
at least one air outlet hole (1121), communicated with the cavity (1111); and
an airflow channel (1141), through which the cavity (1111) communicating with an air pump (102); and
at least one breathing valve assembly (19), coupled with the least one air outlet hole (1121) and each comprising:
a breathing sheet (13), movably covering at least one of the at least one air outlet hole (1121);
an elastic unit (15); and
a counterweight unit (12), connected to the breathing sheet (13) through the elastic unit (15);
wherein a pressure on the breathing sheet (13) generated by a weight of the counterweight unit (12) is greater than a thrust on the breathing sheet (13) generated by air in the cavity (1111) when the air pump (102) is inflating the cavity (1111) for demolding the workpiece.

10. The pad printing carrier according to claim 9, wherein each of the at least one breathing valve assembly (19) further comprises a limiting unit (14) connected to the bucket mold (11); the counterweight unit (12) is connected to the limiting unit (14), the breathing sheet (13) and the elastic unit (15) are movably sleeved on the limiting unit (14).

11. The pad printing carrier according to claim 9, wherein the air inlet hole (1131) and the at least one air outlet hole (1121) are respectively arranged on opposite sides of the bucket mold (11).

12. The pad printing carrier according to claim 9, wherein the bucket mold (11) further comprises an air pipe (114) at a center of a side where the at least one air outlet hole (1121) is located, the airflow channel (1141) is defined inside the air pipe (114).

13. The pad printing carrier according to claim 12, wherein the number of the at least one air outlet holes (1121) is at least two, and the at least two air outlet holes (1121) are arranged around the air pipe (114); each breathing sheet (13) covers at least two air outlet holes (1121).

14. A transmission device, comprising:
a rotating shaft (21) having an axis and horizontally arranged;
a rotating disc (101), connected to the rotating shaft (21) and comprising multiple connecting units (22); and
a plurality of pad printing carriers (10) according to claim 1, the plurality of pad printing carriers (10) are connected to the connecting unit (22) respectively; wherein
the transmission device comprises at least an in-bucket position (30) and an out-bucket position (80), the in-bucket position (30) is level with or above a horizontal plane (HL) on which the axis of the rotating shaft (21) is located, and the out-bucket position (80) is located below the horizontal plane (HL) of the axis of the rotating shaft (21).

15. The transmission device according to claim 14, further comprises an air pump (102), wherein the air pump (102) is used for inflation to form a positive pressure during demolding or suction to form a negative pressure, the air pump (102) is connected to the cavity (1111) through the connecting units (22);
when the pad printing carrier (10) is at the in-bucket position (30), the air pump (102) sucks air to form a negative pressure in the cavity (1111);
when the pad printing carrier (10) is at the out-bucket position (80), the air pump (102) inflates to form positive pressure in the cavity (1111) for demolding.
